(19) United States
(12) Patent Application Publication
(10) Pub. No.: US 2025/0332904 A1
(43) Pub. Date: Oct. 30, 2025

(54) FRONT VEHICLE-BODY STRUCTURE OF VEHICLE IN WHICH BATTERY UNIT IS MOUNTED

(71) Applicant: Mazda Motor Corporation, Hiroshima (JP)

(72) Inventors: Yoshikazu NISHIMURA, Aki-gun (JP); Taiki YOTSUYANAGI, Aki-gun (JP); Akihiro KAWANO, Aki-gun (JP); Ayaka FUKUDA, Aki-gun (JP)

(73) Assignee: Mazda Motor Corporation, Hiroshima (JP)

(21) Appl. No.: 19/172,669

(22) Filed: Apr. 8, 2025

(30) Foreign Application Priority Data
Apr. 26, 2024 (JP) 2024-072762

(51) Int. Cl. B60K 1/04; B62D 25/20; H01M 50/209; H01M 50/249; H01M 50/271

(52) U.S. Cl. CPC B60K 1/04; B62D 25/2036; H01M 50/209; H01M 50/249; H01M 50/271; B60K 2001/0438; H01M 2220/20

(57) ABSTRACT

A front vehicle-body structure including a floor panel; side sills that extend along side edges of the floor panel; front side frames that extend forward from a front side of the floor panel, the front side frames being spaced apart from each other; and a torque box attached to the floor panel, the torque box and the floor panel coupling a rear end part of the front side frames to a front end part of the side sills, wherein a battery unit has a rectangular shape and is below the floor panel and extends along the floor panel, a step part having a lower height than an upper surface of the battery unit is at a front end part of the battery unit, and the torque box is on the step part such that the front end part of the battery unit vertically overlaps with the torque box.

### CROSS-REFERENCE TO RELATED APPLICATION

The present application claims priority to Japanese Patent Application 2024-072762, filed Apr. 26, 2024, the entire contents of which are incorporated herein by reference.

### FIELD

The disclosed technology relates to a front vehicle-body structure of a vehicle in which a battery unit for traveling is mounted, such as an electric vehicle.

### DESCRIPTION OF THE RELATED ART

A front vehicle-body structure of this kind is disclosed in Patent Literature 1.

In the front vehicle-body structure of Patent Literature 1, a pair of left and right front side frames are coupled to a cross member extending in the vehicle width direction. The left and right end parts of the cross member are coupled to a pair of left and right side sills via outriggers.

Each outrigger has an inclined surface on the inner side in the vehicle width direction, the inclined surface being inclined outward in the vehicle width direction toward the rear side. Inclined surfaces are provided at the left and right front corner parts of a battery case. The inclined surfaces and the inclined surfaces of the respective outriggers are disposed to face each other with a clearance therebetween.

### CITATION LIST

### Patent Literature

[Patent Literature 1] Japanese Patent Laid-Open No. 2019-18821

### BACKGROUND

Battery units have large weights and large capacities. For this reason, a battery unit may be below a floor panel having a large area.

However, there may a limitation on the height of the space formed below the floor panel. For this reason, it may be desirable to increase the battery unit in size in the horizontal direction. The front part of a vehicle body may be provided with a pair of front side frames that receive a load acting from the front side of the vehicle.

To transmit the load to the pair of side sills behind the front side frames, the vehicle-body structure of Patent Literature 1 is provided with the cross member and the pair of outriggers. Due to such a configuration, the battery unit of Patent Literature 1 is shaped such that the left and right front corner parts of the battery unit are cut off as viewed from above. The vehicle-body structure of Patent Literature 1 has a disadvantage that the capacity of the battery unit is correspondingly reduced.

In contrast, there may be cases in which a load on respective front side frames is transmitted to the respective side sills via torque boxes having a closed cross-sectional structure excellent in strength and rigidity. To allow the torque boxes to appropriately transmit the load, the torque boxes may have an appropriate volume and may have a small deviation in aspect ratio (the ratio of longitudinal size to lateral size) of the closed cross-section.

If the battery unit were to be increased in size in the forward direction, the battery unit could interfere with the torque box. Accordingly, the battery unit may be arranged in the same manner as the vehicle-body structure of Patent Literature 1 while avoiding the torque boxes. The capacity of the battery unit may be reduced.

In view of the above, this Description discloses a technique that can increase the capacity of a battery unit by increasing a size of the battery unit in the forward direction while the function of torque boxes is appropriately ensured.

### SUMMARY

The disclosed technology relates to a front vehicle-body structure of a vehicle in which a battery unit is mounted.

The front vehicle-body structure includes: a floor panel that constitutes a floor surface of a vehicle cabin of the vehicle; a pair of side sills that extend in a front-rear direction along both left and right side edges of the floor panel; a pair of front side frames that extend forward from a front side of the floor panel while being spaced apart from each other in a left-right direction; and a torque box that has a closed cross-sectional structure formed by attaching a box panel to a lower surface of a front end part of the floor panel, the torque box coupling, in cooperation with the floor panel, a rear end part of each of the pair of front side frames on a left side and a right side to a front end part of each of the pair of side sills.

The battery unit has an external appearance having a rectangular shape as viewed in a top plan view, and is disposed below the floor panel and expands along the floor panel. A step part having a lower height than an upper surface of the battery unit is provided at a front end part of the battery unit, and the torque box is received by the step part, thus causing the front end part of the battery unit to be disposed to overlap with the torque box in an up-down direction.

That is, according to this front vehicle-body structure, by attaching the box panel to the lower surface of the front end part of the floor panel, the torque box having the closed cross-sectional structure is formed. The torque box couples, in cooperation with the floor panel, the rear end part of each of the front side frames on the left side and the right side to the front end part of each of the side sills.

The battery unit disposed below the floor panel to expand along the floor panel has the external appearance having a rectangular shape as viewed in a top plan view. The step part having a lower height than the upper surface of the battery unit is provided at the front end part of the battery unit, and the torque box is received by the step part, thus causing the front end part of the battery unit to be disposed to overlap with the torque box in the up-down direction.

Therefore, it is possible to allow the battery unit to be formed into a rectangular shape having substantially the same size as the floor panel. The battery unit can be increased in size in the forward direction while the function of the torque box is ensured and hence it is possible to achieve a battery unit having a large capacity.

The torque box may include a front wall part facing in a forward direction, a rear wall part facing in a rearward direction, and a lower wall part facing in a downward direction, and the step part may be formed to extend along the lower wall part and the rear wall part.

With such a configuration, it is possible to maximize the capacity of the front end part of the battery unit while an appropriate closed cross-sectional shape of the torque box is ensured.

The torque box may further include a side wall part that faces in a lateral direction, and the torque box may be joined to the front end part of each of the pair of side sills from a plurality of directions.

With such a configuration, a load that acts on the torque box can be appropriately transmitted to the side sill with certainty.

The rear end part of each of the pair of front side frames may be joined to the torque box via the front wall part.

With such a configuration, the torque box receives, from the front side thereof, a load transmitted rearward from the front side frame and hence it is possible to appropriately transmit the load that acts on the front side frame to the torque box with certainty.

The battery unit may include a battery case that houses a battery cell, the battery case may include a frame member having a rectangular shape, and a bottom member and a lid member that are assembled to the frame member to cover an upper side and a lower side of the battery cell, the step part may be constituted of the frame member and the lid member, the frame member facing the lower wall part, the lid member facing the rear wall part, and the frame member may be fixed to the lower wall part.

With such a configuration, the battery unit is supported by the torque box, which is also excellent in strength and rigidity, via the frame member excellent in strength and rigidity and hence it is possible to support the battery unit in a stable manner.

A lower surface of the floor panel including the torque box and an upper surface of the battery case including the frame member and the lid member may face each other with a predetermined gap therebetween.

The battery unit generates heat when in use. By including a gap between the floor panel or the like and the upper surface of the battery case, it is possible to secure a heat radiation or dispersion space having a large surface area above the battery unit. It is possible to promote heat radiation of the battery unit.

### Advantageous Effects

According to the disclosed technology, it is possible to increase the capacity of the battery unit by increasing the battery unit in size in the forward direction while the function of the torque box is appropriately ensured.

### BRIEF DESCRIPTION OF THE DRAWINGS

FIG. 1 is a diagram of a vehicle-body structure to which the disclosed technology is applied, as viewed from above.

FIG. 2 is a perspective view as viewed from a direction shown by arrow A in FIG. 1.

FIG. 3 is a cross-sectional view taken along arrow line B-B in FIG. 1.

FIG. 4 is a cross-sectional view taken along arrow line D-D in FIG. 3.

FIG. 5 is a diagram as viewed from a direction shown by arrow E in FIG. 4.

FIG. 6 is a cross-sectional view taken along arrow line C-C in FIG. 1.

FIG. 7A is a diagram for illustrating the structure of a battery unit.

FIG. 7B is a diagram for illustrating the structure of the battery unit.

FIG. 8 is a diagram for illustrating the structure of a box panel.

FIG. 9 is a perspective view showing a state in which the box panel is attached to a vehicle body.

### DETAILED DESCRIPTION

Hereinafter, the disclosed technology will be described. However, this description is merely exemplary in nature. The front-rear direction, the left-right direction, and the up-down direction used in the description are determined with reference to a vehicle. In the drawings, these directions are shown by arrows. The left-right direction corresponds to a vehicle width direction.

<Vehicle-body structure>

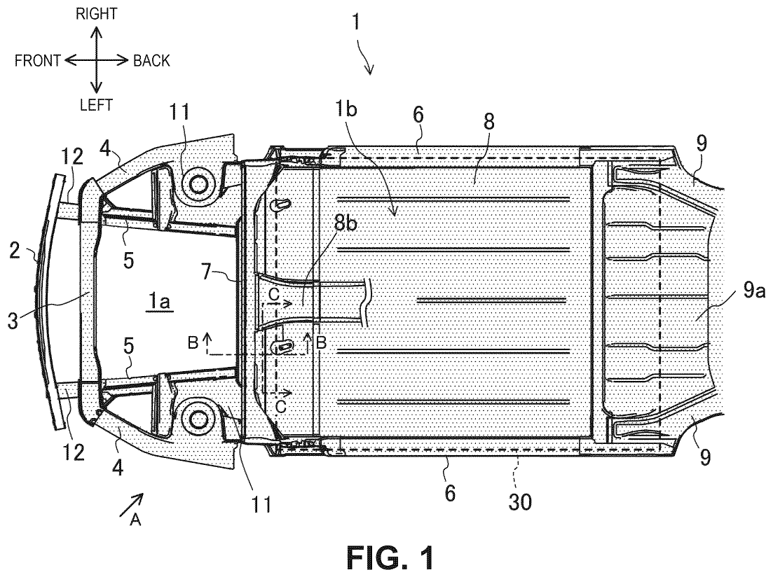

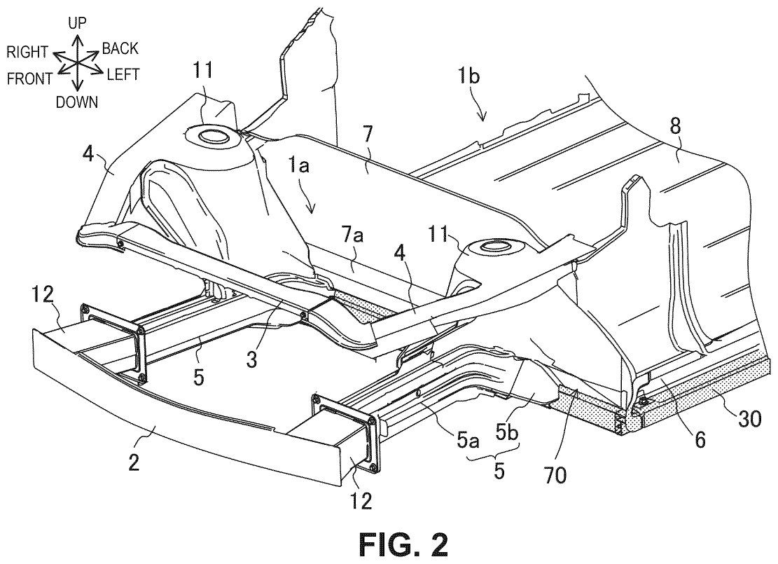

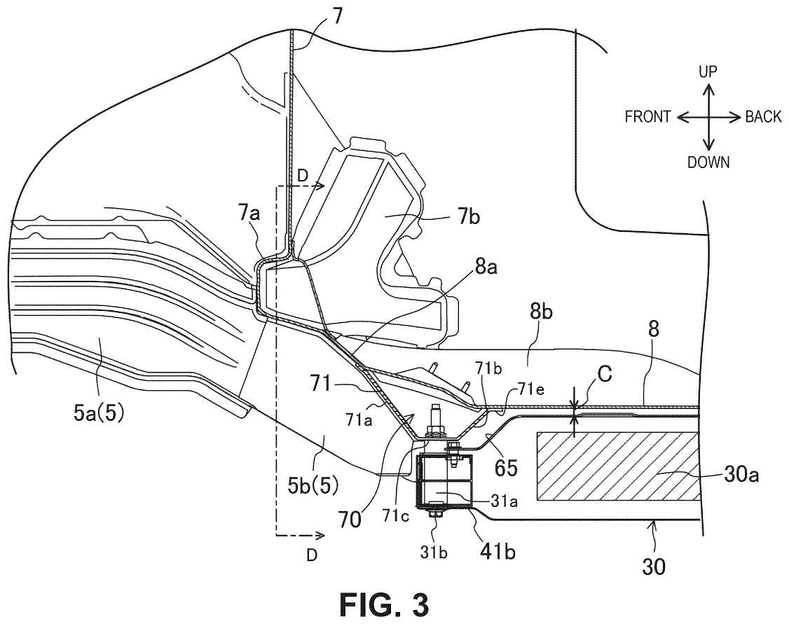

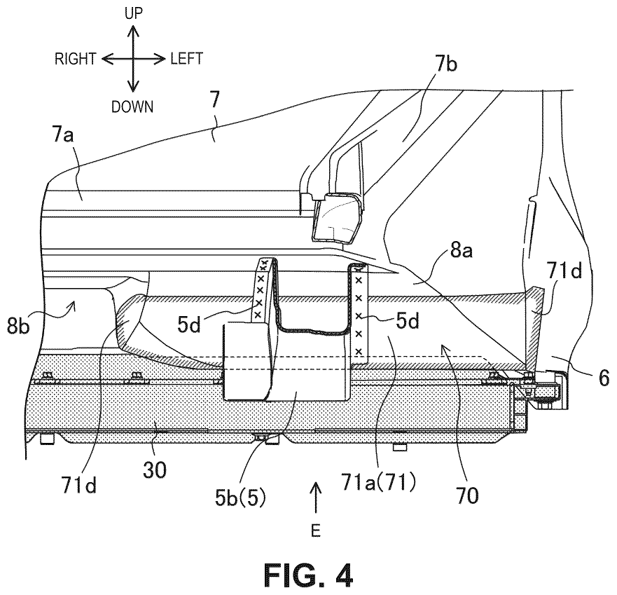

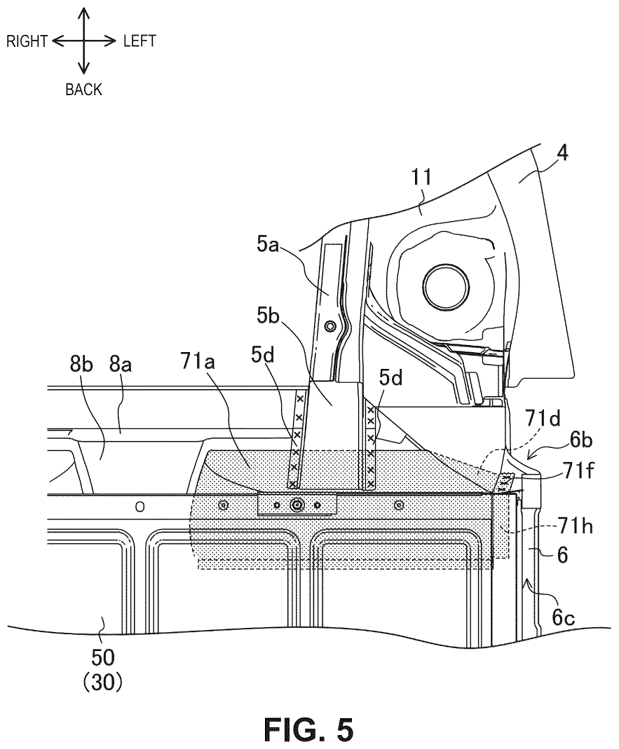

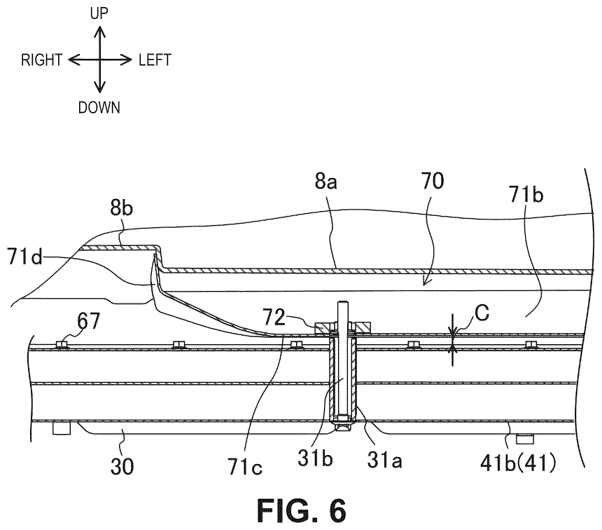

The vehicle-body structure of a vehicle to which the disclosed technology is applied is shown in FIG. 1 to FIG. 6 as an example. FIG. 1 is a diagram of a vehicle body 1 of the vehicle as viewed from above (plan view). FIG. 2 is a perspective view as viewed from a direction shown by arrow A in FIG. 1. FIG. 3 is a cross-sectional view taken along arrow line B-B in FIG. 1. FIG. 4 is a cross-sectional view taken along arrow line D-D in FIG. 3. FIG. 5 is a diagram as viewed from a direction shown by arrow E in FIG. 4 (bottom view). FIG. 6 is a cross-sectional view taken along arrow line C-C in FIG. 1. The vehicle body 1 is shown in FIG. 1 to FIG. 6 in a simplified manner.

The vehicle body 1 may include a bumper beam 2, a shroud upper member 3, apron members 4, front side frames 5, side sills 6, a dash panel 7, a floor panel 8, and the like.

In an implementation, the vehicle may be an electric vehicle. The vehicle may travel by driving a motor. The motor may be mounted in a front space 1a provided at the front part of the vehicle body 1. A vehicle cabin 1b may be formed at the intermediate part of the vehicle body 1. The floor panel 8 (having a substantially rectangular shape as viewed in a top plan view) may be laid at the intermediate part of the vehicle body 1 in such a way as to expand in both the front-rear direction and the left-right direction (in the horizontal direction), e.g., lie in a plane formed by the horizontal directions. The floor panel 8 may constitute the floor surface of the vehicle cabin 1b.

A battery pack or battery unit 30 may be mounted in the vehicle as a power source for driving a motor for traveling. The battery unit 30 may have a high output. For this reason, the battery unit 30 may have a heavy weight and a large capacity. However, an installation space in the vehicle could have limitations. In an implementation, as shown by a broken line in FIG. 1, the battery unit 30 may be below the floor panel 8 in such a way as to expand along or underlie the floor panel 8.

Due to the application of the disclosed technology, the battery unit 30 of the vehicle may have an external appearance having a rectangular shape as viewed in a top plan view, which is substantially the same as that of the floor panel 8. In an implementation, the front end part of the battery unit 30 may be in the vicinity of the front edge of the floor panel 8. The left and right front corner parts of the battery unit 30 may overlap with the left and right front corner parts of the floor panel 8 in the up-down direction. The battery unit 30 will be separately described below.

As shown in FIG. 2, partitioning may be between the front space 1a and the vehicle cabin 1b by the dash panel 7 and may extend in both the up-down direction and the left-right direction (the vertical direction). As shown in FIG. 3, an upward inclined surface part 8a may be at the front end part of the floor panel 8, and the upward inclined surface part 8a may be inclined upwardly toward the front side.

The protruding end of the upward inclined surface part 8a may be coupled to the lower end of the dash panel 7. The dash panel 7 and the floor panel 8 may be formed in an integral body by joining a plurality of steel sheets to which press working is performed. A ridge part 7a may be at the lower end part of the dash panel 7, and the ridge part 7a may extend in the left-right direction in a state of protruding forward.

A reinforcement rib 7b having a closed cross-sectional structure may be behind the ridge part 7a. A bulging part 8b may be at the center portion in the left-right direction of the front end part of the floor panel 8, and the bulging part 8b may extend in a band shape toward the rear side in a state of being raised and bulging upwardly. Torque boxes 70 (the details will be described below) may be attached to the lower surface of the floor panel 8 at positions on both left and right sides of the bulging part 8b by utilizing the upward inclined surface part 8a.

The pair of side sills 6 (excellent in strength and rigidity) may be on both left and right sides of the intermediate part of the vehicle body 1. Each side sill 6 may include a columnar member, and the side sills 6 may extend in parallel in the front-rear direction along both left and right side edges of the floor panel 8. Rear side frames 9 extending rearward may be coupled to the rear ends of the respective side sills 6. A rear floor panel 9a (formed continuously with the floor panel 8) may be laid between these rear side frames 9.

As shown in FIG. 1, FIG. 2, FIG. 3 and others, a pair of front side frames 5 may extend forward from the front side of the floor panel 8 while being spaced apart from each other in the left-right direction. Each front side frame 5 may include a columnar member having a rectangular cross section, and may include a main part 5a and a rear end part 5b. The main part 5a may extend substantially horizontally, the rear end part 5b may extend shortly or slightly downward in an inclined manner from the rear end of the main part 5a.

Each front side frame 5 may be joined to the upward inclined surface part 8a of the floor panel 8 and to the torque box 70 via the rear end part 5b. As shown in FIG. 1 and FIG. 2, in the left-right direction, joined portions of the rear end parts 5b may be at intermediate positions between the center and the left and right side ends of the vehicle body 1. As viewed from the up-down direction, the pair of front side frames 5 may be disposed in a slightly inclined manner in such a way as to increase a distance therebetween as going to the front side.

Suspension housings 11 may be provided in front of the left and right end parts of the dash panel 7. The lower end parts of the respective suspension housings 11 may be coupled to the respective front side frames 5. The apron members 4 may be coupled to the upper end parts of the respective suspension housings 11.

Each apron member 4 may extend forward from the outer side of each suspension housing 11. Each apron member 4 may bend more inward in the vehicle width direction as it goes to the front side. The distal ends of the pair of apron members 4 may be coupled to each other by the shroud upper member 3 extending in the left-right direction.

The bumper beam 2 extending in the left-right direction may be at a position lower than and in front of the shroud upper member 3. The front ends of the respective front side frames 5 may be coupled to both end parts of this bumper beam 2 via crush cans 12.

### <Battery Unit>

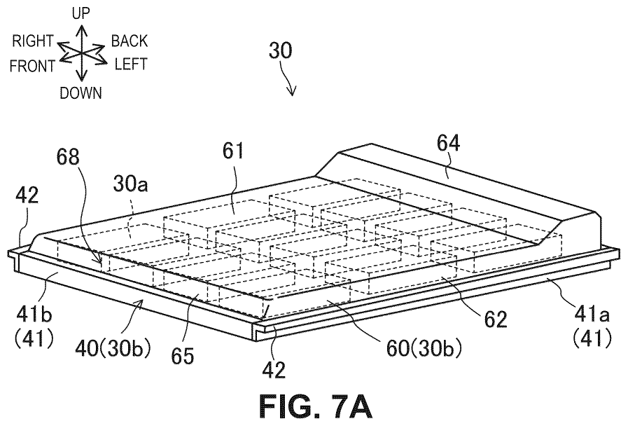

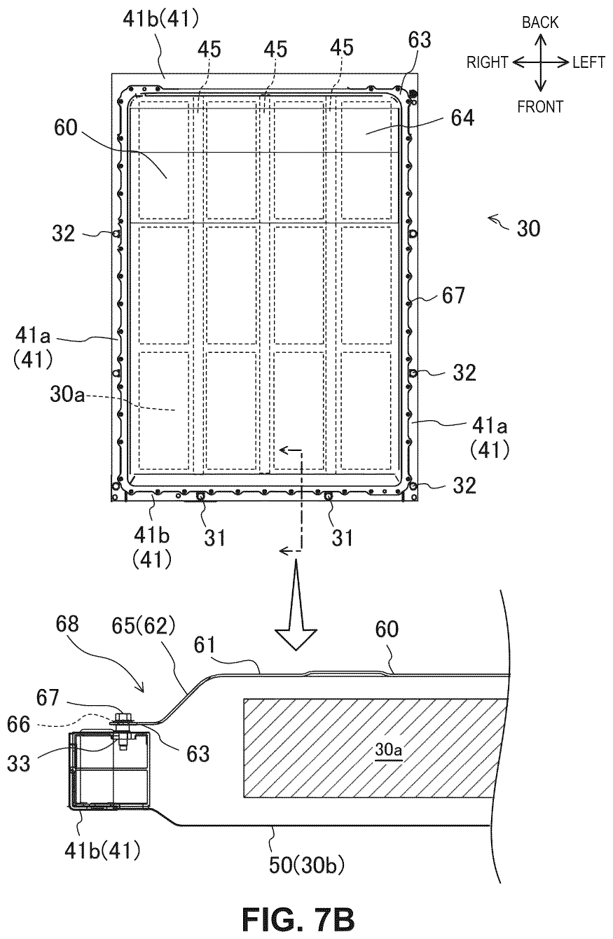

The structure of the battery unit 30 is shown in FIG. 7A and FIG. 7B as an example. The battery unit 30 may include a plurality of battery cells 30a, and a battery case 30b that houses these battery cells 30a.

The respective battery cells 30a may be constituted by connecting a large number of lithium ion batteries or the like. All the battery cells 30a may be electrically connected with each other and configured to be able to output a predetermined high voltage. By taking into account loading efficiency in the battery case 30b, the battery cells 30a may each have a rectangular block shape (rectangular parallelepiped shape). In an implementation, in the battery unit 30, twelve battery cells 30a may be disposed in the battery case 30b to be arranged in the proximity of each other in the horizontal direction such that four battery cells 30a are arranged in the left-right direction and three battery cells 30a are arranged in the front-rear direction.

The battery case 30b may include a battery frame 40, a bottom 50, a lid 60, and the like. The battery frame 40 may include a frame 41 having a rectangular shape, and a plurality of reinforcers 45. Each of the frame 41 and the reinforcers 45 may be a square pipe having a predetermined cross-sectional shape. In an implementation, these may be formed by extrusion molding of, e.g., aluminum.

The frame 41 may include a pair of first frames 41a facing each other in the left-right direction, and a pair of second frames 41b facing each other in the front-rear direction. Each second frame 41b may have a partitioned cross section having a rectangular shape. A front fastening part 31 (the detail will be described below), e.g., front fastening hole, that facilitates fastening to the torque box 70 may be on or in the second frame 41b on the front side (also referred to as “front second frame 41b”) at, e.g., two predetermined bilaterally symmetrical positions.

In an implementation, each first frame 41a may have a partitioned cross section having an inverted L-shaped, and a support part 42 projecting outward may be in or on the upper part of the first frame 41a. A side fastening part 32 (e.g., side fastening hole) that facilitates fastening to the side sill 6 may be in the support part 42 at a plurality of positions spaced apart from each other in the long-length direction. As shown in FIG. 7B in an enlarged manner, screwing parts 33 that facilitate screwing the lid 60 may be provided in or attached to the frame 41 at a plurality of positions.

The reinforcement member 45 may also have a partitioned cross section having a rectangular shape. In an implementation, three reinforcement members 45 may be provided. The respective reinforcement members 45 may extend between the pair of first frames 41a in a state of being parallel to the pair of first frames 41a. The respective reinforcement members 45 may be between the front and rear second frames 41b in such a way as to pass through between the battery cells 30a.

In an implementation, each of the bottom 50 and the lid 60 may be formed by press working on, e.g., an aluminum plate material. The bottom 50 may be joined (e.g., welded) to the lower surface of the frame 41 in such a way as to cover the lower side of the battery cells 30a. The lid 60 that covers the upper side of the battery cells 30a may be fastened to the upper surface of the frame 41.

The lid 60 may have an external appearance having a tray shape with an opening thereof directed downward. In an implementation, the lid 60 may include an upper surface 61, a side surface 62, and a flange surface 63, the upper surface 61 having a rectangular shape as viewed from above, the side surface 62 having a frame shape and having the upper edge thereof formed continuously with the peripheral edge of the upper surface 61, the flange surface 63 projecting from the lower edge of the side surface 62 to an area around it.

A platform 64 may be at the rear part of the lid 60, the platform 64 extending along the rear edge of the lid 60, and having the upper surface 61 located at a raised position. In an implementation, electric components, e.g. a power input/output device or a controller that controls the battery unit 30, may be housed in this platform 64. The side surfaces 62 facing in the left-right direction may be suspended (e.g., may extend downwardly) from the upper surface 61. In an implementation, the side surface 62 facing in the forward direction may be downwardly inclined toward the front side (also referred to as “downward inclined surface 65”).

The flange surface 63 may have fastening holes 66 that facilitate screwing at a plurality of positions corresponding to the arrangement of the screwing parts 33 of the frame 41. By fastening a screw 67 (or other fastener) inserted through each fastening hole 66 to the screwing part 33, the lid 60 may be detachably attached to the frame 41.

By attaching the lid 60 to the frame 41, a step part 68 may be formed at the front end part of the battery unit 30, the step part 68 having a height (e.g., as measured from the bottom 50 in the up-down direction) lower than the height of the upper surface of the battery unit 30, e.g., the upper surface 61. In an implementation, a thickness of the step part 68 in the up-down direction may be less than a thickness of a central region of the battery unit 30. In an implementation, a step-shaped part having a height lower than the height of the upper surface 61 may be formed by the upper surface of the front second frame 41b and the outer surface of the downward inclined surface 65 in such a way as to extend in the left-right direction along the front edge of the battery unit 30.

In an implementation, the torque boxes 70 may be received into (e.g., may be accommodated in or face) the step part 68, such that the front end part of the battery unit 30 and the torque boxes 70 may overlap with each other in the up-down direction. Therefore, it is possible for the battery unit 30 to have a rectangular shape having a size substantially equal to the size of the floor panel 8 (that also has a rectangular shape as viewed in a top plan view). In an implementation, it is possible to enlarge the battery unit 30 in the forward direction while also ensuring the proper function of the torque boxes 70 and hence, it is possible to achieve the battery unit 30 having a large capacity (e.g., without adversely affecting the function of the torque boxes 70).

### <Torque Box and Main Part of Vehicle-Body Structure Related to Torque Box>

If a load were to act on the vehicle from the front side, e.g., due to a collision or the like, the bumper beam 2 receives the load. Most of the load received by the bumper beam 2 may be transmitted rearward via the left and right crush cans 12 and the pair of front side frames 5.

The torque boxes 70 may couple the rear end parts 5b of the left and right front side frame 5 to the front end parts of the side sills 6. In an implementation, the torque boxes 70 may transmit a load that acts on the pair of front side frames 5 to the pair of side sills 6.

To appropriately transmit a load, the torque boxes 70 may satisfy predetermined strength and rigidity. In an implementation, the torque boxes 70 (having a closed cross-sectional structure excellent in strength and rigidity) may be formed by attaching box panels 71 having a specific shape to the lower surface of the front end part of the floor panel 8. These torque boxes 70 may couple the rear end parts 5b of the left and right front side frames 5 to the front end parts of the side sills 6 in cooperation with the floor panel 8.

The vehicle body 1 may include two box panels 71. These box panels 71 may be formed in a bilaterally symmetrical shape. The left and right box panels 71 may be joined and attached to the lower surfaces of the left and right portions of the front end part of the floor panel 8.

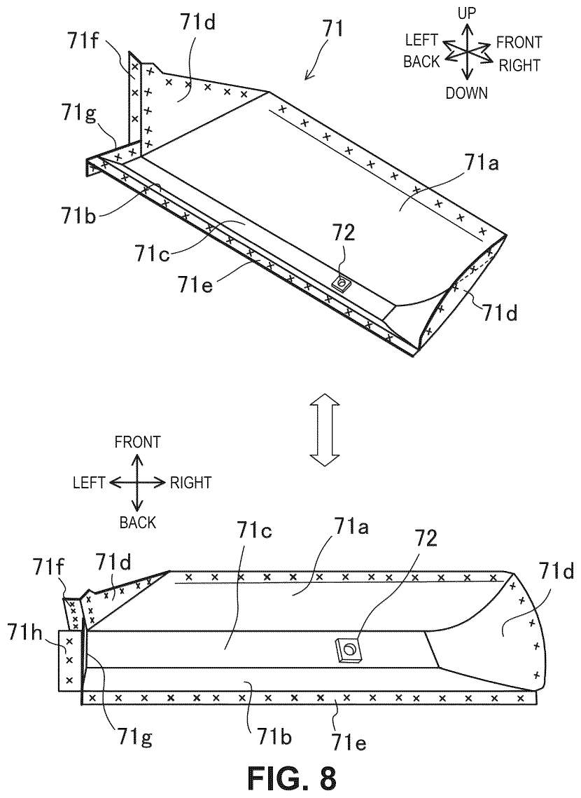

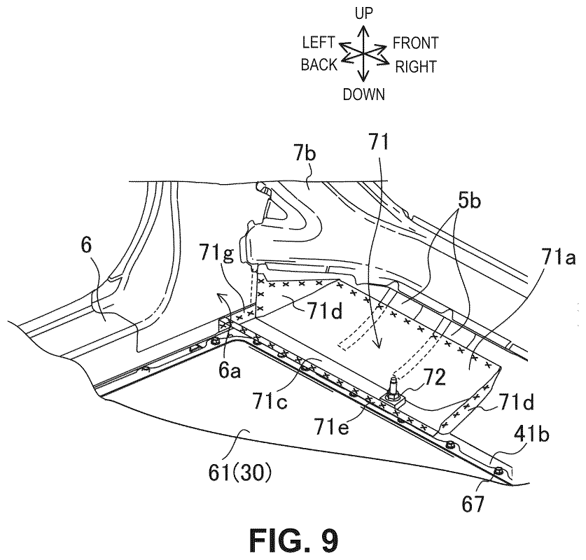

FIG. 8 shows the box panel 71 on the left side as an example. FIG. 9 is a perspective view showing a state in which the box panel 71 is attached to the vehicle body 1. FIG. 9 shows the box panel 71 as viewed from an obliquely right rear position, with the floor panel 8 detached. In the drawing, joined portions are shown by a plurality of cross marks. In an implementation, joining may be performed by spot welding. In the drawing figures, the cross marks do not necessarily represent the positions or the number of joined portions.

The box panel 71 may be a pressed product made of, e.g., a steel sheet. The box panel 71 may include a front wall 71a facing in the forward direction, a rear wall 71b facing in the rearward direction, a lower wall 71c facing in the downward direction, a pair of side walls 71d facing in the lateral direction, and the like (of the side walls 71d, a side wall part 71d facing outward in the vehicle width direction is also referred to as “outer side wall 71d”, and a side wall 71d facing inward in the vehicle width direction is also referred to as “inner side wall 71d”).

The rear wall 71b may include a first flange 71e that projects along the upper edge part of the rear wall 71b. The outer side wall 71d may include a second flange 71f, a third flange 71g, and a fourth flange 71h, the second flange 71f projecting along the rear edge part of the outer side wall 71d, the third flange 71g projecting from the lower end part of the outer side wall 71d along the lower wall 71c and the rear wall 71b, the fourth flange 71h projecting from the lower end of the second flange 71f along the third flange 71g.

The inner side wall 71d may be formed in such a way as to overlap with the side surface shape of the bulging part 8b of the floor panel 8. As shown in FIG. 4 and FIG. 6, the inner side wall 71d may be joined in a state of overlapping with the side surface of the bulging part 8b.

The lower wall 71c may have a band shape that faces the upper surface of the front second frame 41b of the battery unit 30. As shown in FIG. 3 and FIG. 6, the lower wall 71c may extend outwardly in the vehicle width direction substantially horizontally from a portion at which the bulging part 8b is formed at the front end part of the floor panel 8. The lower wall 71c may include a fastening seat 72 that facilitates fastening of a fastener, e.g., a bolt.

The front wall 71a and the rear wall 71b may be inclined upward from the long side parts of the lower wall 71c. The inclination of the front wall 71a may be in conformity with the inclination of the upward inclined surface part 8a at the front end part of the floor panel 8. As shown in FIG. 3 and FIG. 4, the front wall 71a is joined in a state of overlapping with the upward inclined surface part 8a.

The inclination of the rear wall 71b may be in conformity with (e.g., complementary to) the inclination of the downward inclined surface 65 at the front end part of the battery unit 30. As shown in FIG. 3, the rear wall 71b may be joined with the first flange 71e of the rear wall 71b overlapping with the lower surface of the floor panel 8.

The outer side wall 71d may have a triangular or trapezoidal shape that is inclined upward from the inclined outer edge of the front wall 71a. As shown in FIG. 4, FIG. 5, and FIG. 9, the end part of the torque box 70 on the outer side in the vehicle width direction may be joined to the front end part of the side sill 6 from a plurality of directions via the edge part of the outer side wall 71d and second to fourth flanges 71f to 71h.

In an implementation, as shown in FIG. 9, the edge part of the outer side wall 71d and the third flange 71g may be joined to an inner surface 6a of the side sill 6. As shown in FIG. 5, the second flange 71f may be joined to a front end surface 6b of the side sill 6. The fourth flange 71h may be joined to a lower surface 6c of the side sill 6. The torque box 70 may thus be firmly coupled to the front end part of the side sill 6.

Each torque box 70 may have a relatively long dimension in the left-right direction along the front end part of the floor panel 8, and may have a closed cross-sectional structure having a substantially triangular or trapezoidal cross section with a relatively small deviation in aspect ratio as viewed from the left-right direction. Accordingly, these torque boxes 70 may be excellent in strength and rigidity.

As described above, each front side frame 5 may be joined to the upward inclined surface part 8a of the floor panel 8 and to the torque box 70 via the rear end part 5b of the front side frame 5. In an implementation, as shown in FIG. 3, FIG. 4, and FIG. 5, the rear end part 5b of each front side frame 5 may include a frame joint part that is formed in conformity with the shapes of the upward inclined surface part 8a and of the front wall part 71a of the torque box 70.

The frame joint part may include joint flange parts 5d that are brought into surface contact with the upward inclined surface part 8a and the front wall part 71a. By joining the joint flange parts 5d to the front surfaces of the upward inclined surface part 8a and the front wall part 71a, each front side frame 5 may be coupled to the floor panel 8 and the torque box 70.

In an implementation, the respective torque boxes 70 having a closed cross-sectional structure excellent in strength and rigidity may couple the rear end parts 5b of the left and right front side frames 5 to the front end parts of the side sills 6 in cooperation with the floor panel 8. Accordingly, if a load were to act on the respective front side frames 5 from the front side, it is possible to effectively transmit the load to the respective torque boxes 70. Further, it is possible to effectively transmit the load that acts on the respective torque boxes 70 to the respective side sills 6. The torque boxes 70 are allowed to sufficiently exhibit their functions.

As shown in FIG. 7B, the step part 68 may be at the front end part of the battery unit 30. As shown in FIG. 3, the step part 68 may extend along the lower walls 71c and the rear walls 71b of the respective torque boxes 70. Therefore, the front end part of the battery unit 30 and the respective torque boxes 70 may overlap with each other in the up-down direction with a slight clearance C therebetween. Thus, the battery unit 30 may still have a rectangular shape having substantially the same size as the floor panel 8 as viewed from above. As a result, the battery unit 30 may be supported by the pair of torque boxes 70 and the pair of side sills 6, which are excellent in strength and rigidity.

In an implementation, as shown in FIG. 3 and FIG. 6, a bolt support pipe 31a may be attached to each front fastening part 31, the bolt support pipe 31a penetrating through the front second frame 41b in the up-down direction. The upper end part of the bolt support pipe 31a may protrude from the upper surface of the front second frame 41b. A bolt 31b inserted through the bolt support pipe 31a may be fastened and fixed to the fastening seat 72 of the lower wall 71c of each torque box 70.

In an implementation, the respective side fastening parts 32 at the support parts 42 of the first frames 41a may be constituted in the same manner as the front fastening parts 31. In an implementation, bolts inserted through the bolt support pipes of the respective side fastening parts 32 may be fastened and fixed to the respective side sills 6. Thus, the lower surfaces of the floor panel 8 and the torque boxes 70 may face the upper surface of the battery case 30b, including the frame 41 and the lid 60, with a predetermined gap (clearance C) therebetween.

The step part 68 of the battery unit 30 may extend along the lower walls 71c and the rear walls 71b of the torque boxes 70. Accordingly, it is possible to increase the capacity of the battery case 30b to the maximum. In an implementation, the material of the battery case 30b may be aluminum, and the material of the floor panel 8 and the torque boxes 70 may be a steel sheet. The materials may have different thermal expansion coefficients, and if the battery case 30b were to be brought into close contact with the floor panel 8 or the like, there is a possibility that these components could be distorted or deformed.

However, by providing a predetermined clearance C between these components, it is possible to prevent such a distortion or deformation. Further, the battery unit 30 may generate heat when in use. There may be cases in which the battery unit 30 is at a high temperature. By providing the clearance C between the floor panel 8 or the like and the battery case 30b, a heat radiation or dispersion space having a large surface area can be secured above the battery unit 30.

As described above, according to the front vehicle-body structure of the vehicle to which the disclosed technology is applied, it is possible to increase the capacity of the battery unit by increasing the battery unit in size in the forward direction while still ensuring the proper function of the torque boxes.

The disclosed technology is not limited to the embodiments described above, and also includes various other configurations. For example, although an electric vehicle is taken as an example of the vehicle in the embodiments, the vehicle may be a hybrid vehicle. The detailed shapes of the vehicle-body structure, including the box panels 71, and the battery unit 30 may be suitably changed depending on specifications provided that such a change does not affect the application of the disclosed technology.

### REFERENCE SIGNS LIST

1 vehicle body
2 bumper beam
3 shroud upper member
4 apron member
5 front side frame
   5b rear end part
6 side sill
7 dash panel
8 floor panel
   8a upward inclined surface part
   8b bulging part
11 suspension housing
12 crush can
13 coupling plate
30 battery unit
   30a battery cell
   30b battery cell
40 battery frame
41 frame
   41a first frame
   41b second frame
42 support part
45 reinforcement member
50 bottom
60 lid
61 upper surface
62 side surface
63 flange surface
64 platform
65 downward inclined surface
68 step part
70 torque box
71 box panel
   71a front wall
   71b rear wall
   71c lower wall
   71d side wall
72 fastening seat

1. A front vehicle-body structure of a vehicle in which a battery unit is mounted, the front vehicle-body structure comprising:
a floor panel that constitutes a floor surface of a vehicle cabin of the vehicle;
a pair of side sills that extend in a front-rear direction along a left side edge and a right side edge of the floor panel;
a pair of front side frames that extend forward from a front side of the floor panel, the pair of front side frames being spaced apart from each other in a left-right direction; and
a torque box that has a closed cross-sectional structure formed by attaching a box panel to a lower surface of a front end part of the floor panel, the torque box, in cooperation with the floor panel, coupling a rear end part of each of the pair of front side frames on a left side and a right side to a front end part of each of the pair of side sills, wherein
the battery unit has a rectangular shape as viewed in a top plan view, the battery being below the floor panel and extending along the floor panel,
a step part having a lower height than an upper surface of the battery unit is at a front end part of the battery unit, and
the torque box is on the step part such that the front end part of the battery unit overlaps with the torque box in an up-down direction.

2. The front vehicle-body structure of a vehicle according to claim 1, wherein:
the torque box includes a front wall facing in a forward direction, a rear wall facing in a rearward direction, and a lower wall facing in a downward direction, and
the step part extends along the lower wall and the rear wall.

3. The front vehicle-body structure of a vehicle according to claim 2, wherein:
the torque box further includes a side wall that faces in a lateral direction, and
the torque box is joined to the front end part of each of the pair of side sills from a plurality of directions.

4. The front vehicle-body structure of a vehicle according to claim 2, wherein the rear end part of each of the pair of front side frames is joined to the torque box at the front wall.

5. The front vehicle-body structure of a vehicle according to claim 2, wherein:
the battery unit includes a battery case that houses a battery cell,
the battery case includes a frame having a rectangular shape, and a bottom and a lid that are assembled to the frame to cover an upper side and a lower side of the battery cell,
the step part is formed by the frame and the lid, the frame facing the lower wall and the lid facing the rear wall, and
the frame is fixed to the lower wall.

6. The front vehicle-body structure of a vehicle according to claim 5, wherein lower surfaces of the floor panel and the torque box and an upper surface of the battery case, including the frame and the lid, face each other with a predetermined gap therebetween.

7. The front vehicle-body structure of a vehicle according to claim 1, wherein the torque box has a shape that is complementary to a shape of the step part.

8. A front vehicle-body structure of a vehicle in which a battery unit is mountable, the front vehicle-body structure comprising:
a floor panel;
a front end structure;
side support structures; and
a torque box, the torque box including a box panel connected to a lower surface of a front end part of the floor panel, wherein
the torque box and the floor panel couple a rear end of the front end structure to front ends of the side support structures,
the battery unit has a rectangular shape in a top plan view, the battery being below the floor panel and extending along the floor panel,
the battery unit includes a step part at a front end thereof, the step part having a thickness that is less than a thickness of a central region of the battery unit, and
the torque box overlies the step part such that the front end of the battery unit overlaps with the torque box in an up-down direction.

9. The front vehicle-body structure of a vehicle according to claim 8, wherein:
the front end structure includes a pair of front side frames that extend forward from a front side of the floor panel, the pair of front side frames being spaced apart from each other in a left-right direction, and
the side support structures include a pair of side sills that extend in a front-rear direction along a left side edge and a right side edge of the floor panel.

10. The front vehicle-body structure of a vehicle according to claim 8, wherein:
the torque box includes a front wall facing in a forward direction, a rear wall facing in a rearward direction, and a lower wall facing in a downward direction, and
the step part extends along the lower wall and the rear wall in a left-right direction.

11. The front vehicle-body structure of a vehicle according to claim 10, wherein:
the torque box further includes a side wall that faces in the left-right direction, and
the torque box is coupled to the front ends of the side support structures in a plurality of directions.

12. The front vehicle-body structure of a vehicle according to claim 10, wherein the rear end of the front end structure is coupled to the torque box at the front wall.

13. The front vehicle-body structure of a vehicle according to claim 10, wherein:
the battery unit includes a battery case that houses a battery cell,
the battery case includes a frame having a rectangular shape, and a bottom and a lid that are assembled to the frame to cover an upper side and a lower side of the battery cell,
the step part is formed by the frame and the lid, the frame facing the lower wall and the lid facing the rear wall, and
the frame is fixed to the lower wall.

14. The front vehicle-body structure of a vehicle according to claim 13, wherein lower surfaces of the floor panel and the torque box and an upper surface of the battery case face each other with a predetermined gap therebetween.

15. The front vehicle-body structure of a vehicle according to claim 8, wherein the torque box has a shape that is complementary to a shape of the step part.

16. A vehicle including the front vehicle-body structure according to claim 1.

17. A vehicle including the front vehicle-body structure according to claim 8.
